(19) United States
(12) Patent Application Publication
(10) Pub. No.: US 2020/0086537 A1
(43) Pub. Date: Mar. 19, 2020

(54) INJECTION MOLD FOR PRODUCING INJECTION-MOLDED COMPONENTS, AND METHOD FOR PRODUCING INJECTION-MOLDED COMPONENTS

(71) Applicant: Ford Global Technologies, LLC, Dearborn, MI (US)

(72) Inventors: Thomas Baranowski, Wuerselen (DE); Maik Broda, Wuerselen (DE); Markus Franzen, Stolberg (DE); Pascal Rebmann, Weilerswist (DE)

(73) Assignee: Ford Global Technologies, LLC, Dearborn, MI (US)

(21) Appl. No.: 16/571,549

(22) Filed: Sep. 16, 2019

(30) Foreign Application Priority Data
Sep. 14, 2018 (DE) 102018215660.3

(51) Int. Cl. B29C 45/04; B29C 45/73; B29C 45/00

(52) U.S. Cl. CPC B29C 45/04; B29L 2031/748; B29C 45/0005; B29C 45/73

(57) ABSTRACT

An injection mold includes a first mold half with a first mold surface and a second mold half with a second mold surface. The first and second mold surfaces together delimit a cavity when the injection mold is closed. An electrically conductive reinforcing element is arranged on at least one of the first and second mold surfaces and is configured for an electrical voltage to be applied such that the electrically conductive reinforcing element increases in temperature and a viscosity of an injection-molding compound flowing past the electrically conductive reinforcing element decreases. A method for producing injection-mold components using the injection mold includes applying an electrical voltage to the electrically conductive reinforcing element and thereby increasing its temperature such that the viscosity of the injection-molding compound flowing past the electrically conductive reinforcing element decreases as it flows and fills the cavity.

### CROSS-REFERENCE TO RELATED APPLICATIONS

This application claims priority to and the benefit of German Patent Application Number 102018215660.3 filed on Sep. 14, 2018. The disclosure of the above application is incorporated herein by reference.

### FIELD

The present disclosure relates to an injection mold for producing injection-molded components.

### BACKGROUND

The statements in this section merely provide background information related to the present disclosure and may not constitute prior art.

Injection molds are used as a component part of injection-molding machines for producing injection-molded components. In injection molding, material, for example a plastic, is liquefied, for example melted, in an injection-molding machine and injected under pressure into a casting mold. Multicomponent systems, for example mixtures of different plastics, can also be processed by the injection-molding method. The casting mold in this case determines the inner space (the so-called cavity), the shape, and the surface structure of the injection-molded component. Generally, the casting mold is made up of two halves (also referred to as “mold halves”). One of the mold halves is a nozzle side and the mold half lying opposite it is an ejector side. In the mold halves there are further components of the injection mold, for example, ejector components, gating systems, core inserts, at least one mold cavity, and a cooling system (or temperature control system).

The mold halves may be made up of a number of plates. The mold half assigned to the nozzle side does not move during the production of the injection-molded components, that is to say is arranged in a fixed position. The mold half assigned to the ejector side, on the other hand, is movably arranged and can be moved toward the positionally fixed mold half and away from it. Usually, the nozzle-side mold half incorporates so-called mold impressions, which are also referred to as mold inserts or half-shells. These may be a component part of a mold plate assigned to the nozzle-side mold half. The mold impressions form part of the mold surface of the nozzle-side mold half that is facing the shaping interior space or the cavity.

In the mold half that is assigned to the ejector side there are ejector components for ejecting the injection-molded component after completion of the injection-molding operation. Furthermore, on a mold surface facing the interior space or the cavity, this mold half also comprises shaping components, for example shaping cores and inserts. The mold impressions, cores and inserts form the shaping interior space or the cavity.

The size dimensions of the interior space formed by the mold halves and/or of the surface structures provided on the mold surfaces of the mold halves, for example projections or recesses (mold impressions or cores), can determine the shape and surface structure of the injection-molded component. Articles or components may also be arranged in the cavity before the actual injection molding. Such components arranged in the casting mold determine the shape of the cavity during the injection molding, that is to say have a shaping function, like the mold surfaces themselves, for the injection-molded component.

The molten injection-molding compound is conducted by way of a runner system to the interior space or the cavity of the injection mold. This is followed by the gating. Various gating systems are known. The choice of gating system has direct effects on the quality of the injection-molded component. When choosing the gating system, consideration must be given in particular to the shape of the component to be produced. Gating systems that can be mentioned by way of example are the diaphragm gate, the pin gate, the sprue gate, the tunnel gate and the film gate.

It is known to produce the mold halves of injection molds from metal. Such mold halves produced from metal have a long lifetime and mechanical stability. Metals are insensitive to the increased temperatures occurring during the injection molding. However, the relatively high production costs and the relatively long production time are disadvantageous. Generally, mold halves or mold plates produced from metal are cast or forged. In particular because of the mold impressions, core elements or cavities to be formed on the mold halves, production is relatively complex. If a producer of injection-molded components wishes to modify the structure or shape of its injection-molded components, it is reliant on ordering mold halves or mold plates that are adapted to the modified shape, or having them made. This presents disadvantages in terms of time and cost. The quickest possible adaptability of the casting molds or mold halves is especially important in particular to research and development departments that are producing prototypes of certain injection-molded components.

Production by the 3D printing process offers one possibility of producing mold halves or associated mold plates of an injection mold in a quick and flexible way. In the 3D printing process, certain components, here for example the mold halves or mold plates assigned to the mold halves, can be produced in a computer-controlled manner by material being applied layer by layer to a carrier. The application of the material is based on prescribed dimensions and shapes, which may for example be prescribed by a user in a CAD format. In particular, the production of mold halves from plastic by 3D printing is of particular interest for use in an injection mold. This is so because 3D printing of plastics is relatively inexpensive in comparison with 3D printing of metals. However, when selecting the plastic, its melting temperature should be above the processing temperature of the plastic processed during the injection molding. Since otherwise the shaping mold halves would melt. A disadvantage of the use of mold halves of plastic appears to be the relatively low mechanical stability and longevity, in particular in comparison with mold halves produced from metal. This applies in particular because relatively high pressures in combination with increased temperatures can occur in the interior space of the injection mold during the injection molding.

### SUMMARY

The present disclosure provides an injection mold for producing injection-molded components and a method for producing injection-molded components with an injection mold which allows flexible adaptability of the injection mold to different shapes of the components to be produced, increased mechanical stability and reliable formation even of fine structures in the injection-molded components.

The present disclosure further provides an injection mold for producing injection-molded components in which at least one electrically conductive reinforcing element is arranged on at least one of the mold surfaces and is designed for an electrical voltage to be applied to it, at least during the injection molding. The present disclosure also provides a method for producing injection-molded components in which an electrical voltage is applied to the reinforcing element, at least during the injection of the injection-molding compound.

In one form of the present disclosure, an injection mold for producing injection-molded components is provided. The injection mold comprises a first mold half with a first mold surface, and a second mold half with a second mold surface. The mold surfaces are such that they together delimit a cavity when the injection mold is closed. At least one electrically conductive reinforcing element is arranged on at least one of the mold surfaces.

As described above, injection molds are generally made up of two mold halves, which in turn may be made up of a number of plates. A component part of the mold halves may be for example a mold plate, which has shaping structures for the injection-molded component. In one form of the present disclosure, the mold halves are produced from plastic, for example by way of 3D printing. In one variation of the present disclosure, just the mold plates are produced from plastic, for example by 3D printing. The melting temperature of the plastic forming the mold halves or mold plates is greater than the processing temperature of the injection-molded compound that is injected into the cavity, since otherwise the mold halves or mold plates themselves would melt during the injection molding.

One of the mold halves forms a nozzle-side mold half, while the other mold half provides an ejector-side mold half. The nozzle-side mold half is arranged in a fixed position, while the ejector-side mold half is bi-directionally movable in the direction of the positionally fixed mold half. One of the mold halves can therefore be moved toward the other mold half and away from it. In the closed state of the injection mold, mold surfaces provided on the mold halves form an interior space or a cavity, which has a shaping function for the injection-molding compound flowing in by way of a gating or nozzle system during the injection molding. The mold surfaces may also be formed on a mold plate as a component part of the respective mold halves. For the shaping of the injection-molded components, recesses or projections may be provided on the mold surfaces, referred to in the art as mold impressions and cores.

The electrically conductive reinforcing element may be electrically contacted during the injection molding, i.e., an electrical current flows through the electrically conductive reinforcing element. Electrical contacting is accompanied by an increase in temperature of the electrically conductive reinforcing element. The heat generated thereby increases the temperature of the injection-molding compound flowing past the electrically conductive reinforcing element and into the mold cavity. If the injection-molding compound is a plastics compound, for example a polymer melt, the temperature increase can lead to a reduction in the viscosity of the polymer. This in turn leads to a reduction of the melt pressure desired to fill the mold cavity and makes it easier for the polymer melt to adapt itself to the shape of finely formed structures on the first or second mold surface. Consequently, even extremely small structures, for example narrow mold impressions or interspaces arranged between mold cores, can be filled with the polymer melt.

Furthermore, the electrically conductive reinforcing element leads to an increase in the mechanical stability of the mold halves. In particular, this leads to an increase in the resistance of the mold halves or mold plates and the mold surfaces formed on them with respect to the stresses or pressures occurring during the injection molding.

According to one aspect of the present disclosure, the reinforcing element is a fiber-reinforced tape, the tape comprising a plastic matrix and fibers embedded therein. Said tape may be in particular a unidirectional (UD) tape. A UD tape is a unidirectionally reinforced composite material comprising continuous fibers embedded in a plastic matrix. As a result of the fiber reinforcement, UD tapes have very high strength and stiffness values in the direction of the fibers. By arranging a UD tape in highly stressed regions of the mold halves or mold surfaces, said components can be mechanically strengthened locally.

According to one advantageous form, the fibers are selected from the group of carbon fibers, metal fibers, glass fibers, plastic fibers and combinations thereof. They may also be recycled fibers. The fiber reinforcement has the effect of further increasing the stability of the mold halves. It is also conceivable to provide a mixture of different fibers in the plastic matrix. The fibers are preferably electrically conductive fibers. Equally, the tape may comprise electrically conductive fillers, which may be provided as an alternative or in addition to the electrically conductive fibers in the UD tape. The electrically conductive fibers or fillers may be connected to a voltage source. The voltage source may connect to the UD tape arranged on the mold surfaces outside the injection mold, for example by contacting a UD tape projecting outward from one of the mold surfaces. Similarly, the voltage source may connect to the UD tape in the mold halves or mold plates or the in the mold surfaces. For example, conductive wires may be integrated in the mold halves. Then, the wires can connect to the UD tapes directly and also be led out of the mold halves to the outside, in order to be connected there to the voltage source. Solid sealing of the contact points between the voltage source and the UD tape is desired. As an alternative or in addition to this, an electrically conductive adhesive may be provided, by means of which the UD tape is fastened on the mold surfaces.

In at least one form of the present disclosure, the UD tape comprises unidirectionally oriented continuous fibers. Unidirectionally means in this connection that the fibers run along a specific preferential direction of the tape. In this case, the fibers may be distributed randomly or homogeneously in the plastic matrix. The plastic matrix may in principle be formed by any suitable plastic, in particular however by thermoplastics. The plastic matrix may be preimpregnated with an adhesive resin and, before being laid, be wound up on a roll.

As already indicated, according to a further advantageous form, the tape may be connected to the first and/or second mold surface by way of an adhesive bond. The adhesive used for this may additionally be electrically conductive. The use of an adhesive makes a flexible and manual arrangement of the UD tapes on the mold surfaces possible. Moreover, adhesive bonds are releasable relatively easily, whereby a reversible arrangement of the UD tapes is made possible.

According to another form, the tape arranged on the first and/or second mold surface may be a tape laid with a laser-assisted tape-laying process. For laying the tapes on the mold surfaces, the tapes may be automatically drawn off from a roll and brought to a desired position. If the tape has been preimpregnated with an adhesive resin, it is heated in situ by a laser beam. As a consequence of this, the adhesive resin melts and makes it possible for the tape to bond with the mold surfaces in a finely dispersed manner.

According to a further advantageous form, the tape may be connected to an electrical voltage source such that an electrical voltage can be introduced into the tape. Contact wires integrated in the mold halves, conductive adhesives or external contacts can be used to connect the contact to the electrical voltage source and the UD tape. An electrical contact connection between the electrical voltage source and the ID tape is made when the mold is in the closed position. The electrical contact connection allows an electrical voltage to be applied to the reinforcing element or UD tape, in particular during the injection of the injection-molding compound into the cavity. As a consequence of the applied electrical voltage, the UD tape heats up. The heat generated thereby increases the temperature of the injection-molding compound flowing in during the injection-molding operation. If the injection-molding compound is a plastics compound, for example a polymer melt, the temperature increase can lead to a reduction in the viscosity of the polymer. This in turn leads to a reduction of the melt pressure need to fill the mold cavity and makes it easier for the polymer melt to adapt itself to the shape of finely formed structures on the first or second mold surface. Consequently, even extremely small structures, for example mold impressions or interspaces arranged between mold cores, can be filled with the polymer melt.

According to one form of the present disclosure, the first and second mold halves are printing products of a 3D printer. Equally, mold plates assigned to the mold halves may be 3D printing products.

Mold halves or mold plates produced by way of a 3D printing process may be produced in a computer-controlled manner by additive material application layer by layer. The application of the material is based on prescribed dimensions and shapes, which may for example be prescribed by a user in a CAD format. In this way, mold halves and mold plates can be produced in any desired shapes or adapted. However, when selecting the plastic to be printed, its melting temperature should be above the processing temperature of the plastic processed during the injection molding. Since otherwise the mold halves would melt.

The present disclosure provides a method for producing injection-molded components with an injection mold, wherein the injection mold comprises a first mold half with a first mold surface and a second mold half with a second mold surface, and wherein the mold surfaces are such that they together delimit a cavity when the injection mold is closed, and wherein at least one electrically conductive reinforcing element is arranged on at least one of the mold surfaces. The method includes closing the mold halves and injecting injection-molding compound into the cavity. The mold halves are opened and the injection-molded component is discharged thereby cooling the component.

At least during the injection of the injection-molding compound, an electrical voltage is applied to the electrically conductive reinforcing element. As already stated above, relatively inexpensive and flexible production of injection-molded components is made possible by the method of the present disclosure. As a result, even injection-molded components that are highly complex and provided with fine structures can be produced reliably and inexpensively. This is so on the one hand because the mold halves can be flexibly adapted to specific structural requirements in the course of a 3D printing process. On the other hand, the applied electrical voltage allows the viscosity of the polymer melt to be reduced, whereby the production of fine structural elements is made possible. Also, production of the mold halves or mold plates by way of a 3D printing process is relatively inexpensive in comparison with production of mold halves from metal.

The injection mold and also the method can be combined with all of the forms and aspects described above, while the aforementioned features may be present individually or in any combination.

It should additionally be pointed out that terms such as “comprising”, “have” or “with” do not exclude other features or steps. Furthermore, terms “a” or “the” referring to a singular number of steps or features do not exclude a plurality of features or steps, and vice versa.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic representation of two mold halves of an injection mold (dispensing with the representation of further components of the injection mold) according to the prior art;

FIG. 2 shows a schematic representation of a mold half for an injection mold and/or a method according to the teachings of the present disclosure; and

FIG. 3 shows a schematic representation of a unidirectional tape, as used as a reinforcing element for the injection mold and/or the method according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

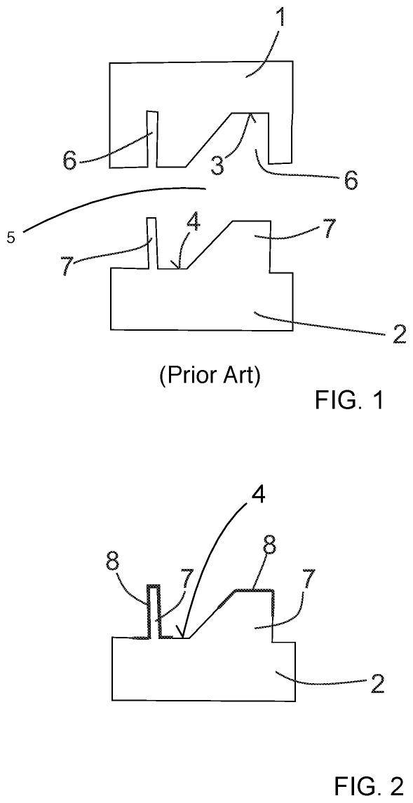

Referring now to FIG. 1, a highly schematized representation of a first mold half 1 and a second mold half 2 of an injection mold according to the prior art is shown. The first mold half 1 has a first mold surface 3 and the second mold half 2 has a second mold surface 4. The mold surfaces 3, 4 form a cavity 5 or the interior space of the injection mold. A softened injection-molding compound, for example a plastics compound, is injected into the cavity 5. The shape of the injection-molded component is defined by shaping elements or the shape of the mold surfaces 3, 4. Shaping elements may be formed for example as mold impressions 6 or cores 7.

The injection-molding compound passes through a gating system (not represented) into the interior space or the cavity 5 of the injection mold. As already stated at the beginning, one of the mold halves 1, 2 is arranged in a fixed position, in particular a nozzle-side mold half. The other of the mold halves 1, 2, in particular the mold half 1, 2 assigned to an ejector side, is arranged movably in relation to the nozzle-side mold half 1, 2. Before the actual injection molding, the mold halves 1, 2 are moved toward one another, in order to close the cavity 5 or the interior space of the casting mold. Then, the injection-molding compound, for example a plastics compound, passes through the gating system and a nozzle-side mold half 1, 2 into the cavity or the interior space. After completion of the injection-molding process, the ejector-side mold half 1, 2 is moved away from the nozzle-side mold half 1, 2 and the injection-molded component is removed by ejector elements (not shown) provided on the nozzle-side mold half 1, 2, for example an ejector plate or ejector bolt, i.e. it is ejected.

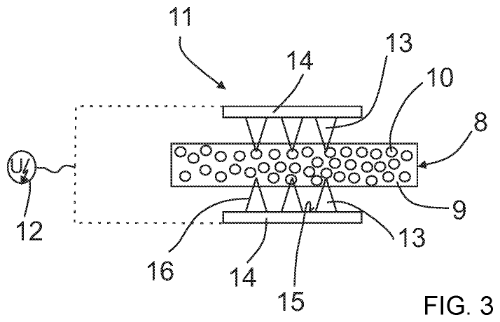

Referring to FIG. 2, the mold surfaces 3, 4 of the respective mold halves 1, 2 may be provided with a reinforcing element 8 (only mold surface 4 of mold halve 2 shown). In one aspect of the present disclosure, the reinforcing element 8 is a UD tape, that is to say a tape made up of a plastic matrix 9 and electrically conductive fibers 10 embedded therein (as shown in FIG. 3). The reinforcing element 8 or UD tape may be provided over the full surface area on one of the mold surfaces 3, 4 or on both mold surfaces 3, 4. As represented, it is also possible however for only certain regions of the mold surfaces 3, 4 to be provided with the UD tape, for example the portions defining the cores 7 of the mold halves 1, 2. The UD tape may be adhesively attached on the mold surfaces 3, 4 with a suitable adhesive. The UD tape may also be self-adhesive. Alternatively, the UD tape may be arranged on the mold surfaces 3, 4 by way of a laser-assisted tape laying process. The arrangement of UD tapes or portions of UD tape leads to a structural strengthening of the portions of the mold halves 1, 2 covered with them. As used herein, the term “strengthening” refers to an increase of the mechanical stability or stiffness. Also, the arrangement of the UD tape leads to a structural stabilization of the components to which it is applied in the sense of a fiber-reinforced composite material.

Referring to FIG. 3, fibers 10 embedded in a plastic matrix 9 of the UD tape may be electrically conductive and electrically contacted by way of a suitable electrical contact 11 (also referred to herein simply as “contact”). The contact 11 may, as schematically represented in FIG. 3, be formed like a clamp, in order to electrically contact the UD tape. For this, part of the tape may be led out or extend from the cavity 5, in order to be electrically contacted outside the cavity 5. Nevertheless, contact 11 may be provided within the cavity 5, or be integrated in the mold surfaces 3, 4. When arranging the UD tape, it may be contacted by way of the contact 11 integrated in the mold surfaces 3, 4. The contact 11 may be brought into connection with the UD tape by way of an electrically conductive medium, for example by way of an electrically conductive adhesive or contact wire. The contacting of the reinforcing element 8 by way of the contact 11, as represented by way of example in FIG. 3, shows contacting by way of tooth-shaped contact pins 13, which extend from a base 14 in the form of teeth, tapering to a point in the direction of the reinforcing element 8. Individual contact pins 13 are separated by tooth bases 15. The tooth-shaped contact pins 13 are delimited by tooth flanks 16. The contact pins 13 may protrude into the plastic matrix 9 of the reinforcing element 8 and contact electrically conductive fillers contained in the plastic matrix 9. Nevertheless, the contact pins 13 may directly contact the electrically conductive fibers 10.

Via the electrical contacting, an electrical voltage ‘V’ can be applied to the reinforcing element 8. It should be understood that applying the electrical voltage V to the reinforcing element 8 can provide particular advantages, in particular during the injection of the injection-molding compound into the cavity 5. For example, the UD tape heats up as a consequence of the applied electrical voltage V and the heat generated thereby increases the temperature of the injection-molding compound flowing in the cavity 5. If the injection-molding compound is a plastics compound, for example a polymer melt, the temperature increase can lead to a reduction in the viscosity of the polymer. This in turn leads to a reduction of the melt pressure and makes it easier for the polymer melt to adapt itself even to the shape of finely formed structures on the first or second mold surface 3, 4. Consequently, even extremely small structures, for example mold impressions 6 or interspaces arranged between mold cores 7, can be filled with the polymer melt. The electrical contacting together with the accompanying increase in temperature in the cavity 5 of the injection mold ultimately makes possible even the formation of finely structured injection-molded components.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice; material, manufacturing, and assembly tolerances; and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An injection mold for producing injection-molded components, the injection mold comprising:
a first mold half with a first mold surface and a second mold half with a second mold surface, wherein the first mold surface and the second mold surface together delimit a cavity when the injection mold is closed; and
at least one electrically conductive reinforcing element arranged on at least one of the first mold surface and the second mold surface, wherein the at least one electrically conductive reinforcing element is configured to receive an electrical voltage during injection molding such that the at least one electrically conductive reinforcing element increases in temperature.

2. The injection mold according to claim 1, wherein the at least one conductive reinforcing element is a fiber-reinforced tape comprising a plastic matrix and fibers embedded in the plastic matrix.

3. The injection mold according to claim 2, wherein the fibers are selected from the group consisting of carbon fibers, metal fibers, glass fibers, plastic fibers, and combinations thereof.

4. The injection mold according to claim 2, wherein the fibers are electrically conductive.

5. The injection mold according to claim 2, wherein the fiber-reinforced tape comprises electrically conductive fillers.

6. The injection mold according to claim 1, wherein the least one electrically conductive reinforcing element comprises unidirectionally oriented continuous fibers.

7. The injection mold according to claim 1, wherein the at least one electrically conductive reinforcing element is connected to at least one of the first mold surface and the second mold surface with an adhesive bond.

8. The injection mold according to claim 1, wherein the least one electrically conductive reinforcing element arranged on at least one of the first mold surface and the second mold surface is a fiber-reinforced tape arranged on at least one of the first mold surface and the second mold surface with a laser-assisted tape-laying process.

9. The injection mold according to claim 1, wherein the least one electrically conductive reinforcing element is connected to an electrical voltage source configured to apply the electrical voltage to the least one electrically conductive reinforcing element.

10. The injection mold according to claim 1, wherein the first mold half and the second mold half are printing products of a 3D printer.

11. An injection mold for producing injection-molded components, the injection mold comprising:
a first mold half with a first mold surface and a second mold half with a second mold surface, wherein the first mold surface and the second mold surface together delimit a cavity when the injection mold is closed; and
an electrically conductive fiber-reinforced tape arranged on at least one of the first mold surface and the second mold surface, wherein the electrically conductive fiber-reinforced tape is configured to receive an electrical voltage during injection molding such that the electrically conductive fiber-reinforced tape increases in temperature, thereby decreasing a viscosity of a polymer flowing past the electrically conductive fiber-reinforced tape.

12. The injection mold according to claim 11, wherein the electrically conductive fiber-reinforced tape comprises a plastic matrix and fibers embedded in the plastic matrix.

13. The injection mold according to claim 12, wherein the fibers are selected from the group consisting of carbon fibers, metal fibers, glass fibers, plastic fibers, and combinations thereof.

13. The injection mold according to claim 11, wherein the electrically conductive fiber-reinforced tape is attached to at least one of the first mold surface and the second mold surface with an adhesive bond.

14. The injection mold according to claim 11, wherein the electrically conductive fiber-reinforced tape is arranged on at least one of the first mold surface and the second mold surface with a laser-assisted tape-laying process.

15. The injection mold according to claim 11, wherein the electrically conductive fiber-reinforced tape is connected to an electrical voltage source configured to apply the electrical voltage to the electrically conductive fiber-reinforced tape.

16. A method for producing injection-molded components with an injection mold, the method comprising:
closing a first mold half with a first mold surface and a second mold half with a second mold surface such that a cavity is delimited by the first mold surface and the second mold surface, wherein at least one electrically conductive reinforcing element is arranged on at least one of the first mold surface and the second mold surface;
applying an electrical voltage to the at least one electrically conductive reinforcing element during injecting injection-molding compound into the cavity and forming an injection-molded component, wherein the injection molding compound flows past the at least one electrically conductive reinforcing element when the electrical voltage is applied.

17. The method according to claim 16, wherein applying the electrical voltage to the at least one electrically conductive reinforcing element during injection of the injection-molding compound into the cavity reduces a viscosity of the injection-molding compound flowing past the at least one electrically conductive reinforcing element such that mold impressions or interspaces arranged between mold cores are filled with the injection-molding compound.

18. The method according to claim 16, wherein the at least one electrically conductive reinforcing element is a fiber-reinforced tape that is arranged on at least one of the first mold surface and the second mold surface with a laser-assisted tape-laying process.

19. The method according to claim 16, wherein the least one electrically conductive reinforcing element is attached on at least one of the first mold surface and the second mold surface with an adhesive bond.

20. The method according to claim 16, wherein the at least one electrically conductive reinforcing element is a fiber-reinforced tape comprising a plastic matrix and fibers embedded in the plastic matrix.
